(19) United States
(12) Patent Application Publication
(10) Pub. No.: US 2013/0342129 A1
(43) Pub. Date: Dec. 26, 2013

(54) FLICKER PREVENTION WITH SWITCHED BULK CAPACITOR

(71) Applicant: Peter VAUGHAN, Los Gatos, CA (US)

(72) Inventor: Peter VAUGHAN, Los Gatos, CA (US)

(73) Assignee: Power Integrations, Inc., San Jose, CA (US)

(21) Appl. No.: 13/528,618

(22) Filed: Jun. 20, 2012

(51) Int. Cl. H05B 37/02; H02M 7/06

(52) U.S. Cl. 315/240; 363/126

(57) ABSTRACT

This relates to an apparatus and method for selectively adding a capacitance to an input of a power converter of a power conversion system. A power conversion system may selectively introduce additional input capacitance in response to an input voltage. In one example, a power conversion system operates in a first mode (dimming mode) and engages a selective capacitor circuit to introduce additional capacitance to an input of a power converter. In a second mode (non-dimming mode), the power conversion system disengages the selective capacitor circuit from the input of the power converter.

### BACKGROUND

1. Field

The present disclosure relates generally to power converters and, more specifically, the present disclosure relates to reducing flicker using a switched bulk capacitor.

2. Related Art

Many electronic devices, such as cell phones, laptops, etc., are powered by a source of direct current (dc) power. Conventional wall outlets generally deliver a high voltage alternating current (ac) power that needs to be transformed to dc power in order to be used as a power source by most consumer electronic devices. Switched mode power converters are commonly used due to their high efficiency, small size, and low weight to convert the high voltage ac power to a regulated dc power. In one example, switched mode power converters are used to provide regulated power to light emitting diode (LED) devices.

An important consideration for a switched mode power converter is the shape and the phase of the input current drawn from the power source relative to the ac input voltage. The shape of the ac input voltage is typically sinusoidal but because a switching power converter presents itself as a non-linear load, the shape of the input current drawn from the power source may become distorted (non-sinusoidal) and/or out of phase with ac input voltage. This results in increased power loss in the power distribution systems.

Correction of the input current waveform to reduce shape and/or phase mismatch with respect to input voltage is referred to as power factor correction (PFC) and often requires an additional input stage with low input capacitance to be added to the power converter to provide the correction. If the input current is sinusoidal and perfectly in-phase with the input voltage, the power factor of the power supply is optimal. In other words, none of the energy delivered to the load is returned to the power source. However, as the switched mode power supply distorts the wave shape of the input current and/or introduces a phase shift with respect to the input voltage, the power factor decreases. Several regulatory agencies have recently set tight standards that typically stipulate for greater power factors and/or lower harmonic content of the input current. Since most LED systems employ some form of PFC to meet these requirements, the input of the power converter may have a low input capacitance.

In one example, switched mode power converters that employ PFC are used to provide regulated power for lighting applications that may include LEDs. Lighting applications may include a particular feature that allows the user to reduce the brightness. Specifically, in lighting applications, reducing the brightness of the lighting device may be referred to as dimming and is accomplished by limiting the power supplied to the lighting device. In one practice, dimming can be realized by implementing phase dimming, where a portion of the ac input voltage, also referred to as ac line signal, is blocked from being received by the lighting device to reduce the amount of power delivered. In phase dimming, the portion of the input voltage that is blocked is measured by a phase angle that represents a portion of the period of the input voltage measured in degrees. One period may be defined as one complete line cycle and corresponds to 360 degrees. Similarly, half the period of input voltage is referred to as a half line cycle and corresponds to 180 degrees.

A power converter may include a triode for alternating current (triac) dimmer to implement phase dimming in a lighting system. Specifically, a triac may represent a semiconductor component that behaves as a switch used to block a portion of the input voltage from the input of the power converter. In operation, when the triac is disengaged (turned off), flow of input current to the power converter is substantially restricted and the ac line is blocked from the input of the power supply. Conversely, when the triac is engaged (turned on), flow of input current is again permitted and the ac line is unblocked from the input of the power supply. The triac may remain engaged and continue to conduct current until the current through the triac drops below a threshold value commonly known as a holding current, which is illustrated by “Holding Current” shown in FIG. 1.

As shown in FIG. 1, additional voltage and current waveforms depict the operation of a triac dimmer. Specifically, waveform 104 represents a half cycle voltage at the output of a triac dimmer superimposed on a half cycle input voltage, and waveform 102 represents a corresponding triac current over the same period. The voltage produced at output of the triac dimmer will be referred herein as a phase dimmed voltage. As shown in FIG. 1, the triac is disengaged and remains turned off between t0 and t1, during which ac input voltage is blocked. In this manner, the triac reduces the phase angle of the phase dimmed voltage and hence, the power delivered to the power converter. Implementing phase dimming in an LED system with a triac dimmer, however, may prove challenging for several reasons, with the triac itself being one of them. For example, when the triac turns on at t1, voltage across the switch suddenly increases as indicated by the initial spike of triac current 102. Because of the inherent parasitic inductive and capacitive components inside the triac, this sharp voltage leads to ringing in triac current 102, which may ultimately cause the triac to misfire. Specifically, due to the ringing, the triac may conduct insufficient current (less than the holding current) to remain engaged, and turn off, thus interrupting the phase dimmed voltage. This is illustrated in FIG. 1 during time periods t2-t3 and t4-t5 where the triac misfires (stops conducting current) and subsequently, the phase dimmed voltage 104 drops to zero volts.

Triac misfires usually happen at different times in consecutive input voltage cycles and as such, energy delivered to the LED lamp varies from one cycle to another, resulting in perceivable fluctuation of light output of the LED lamp.

### BRIEF DESCRIPTION OF THE DRAWINGS

Non-limiting and non-exhaustive embodiments of present invention are described with reference to the following figures, wherein like reference numerals refer to like parts throughout the various views unless otherwise specified.

FIG. 1 shows example waveforms that correspond to various voltage and current signals of a triac dimmer in accordance with the teachings of the present disclosure.

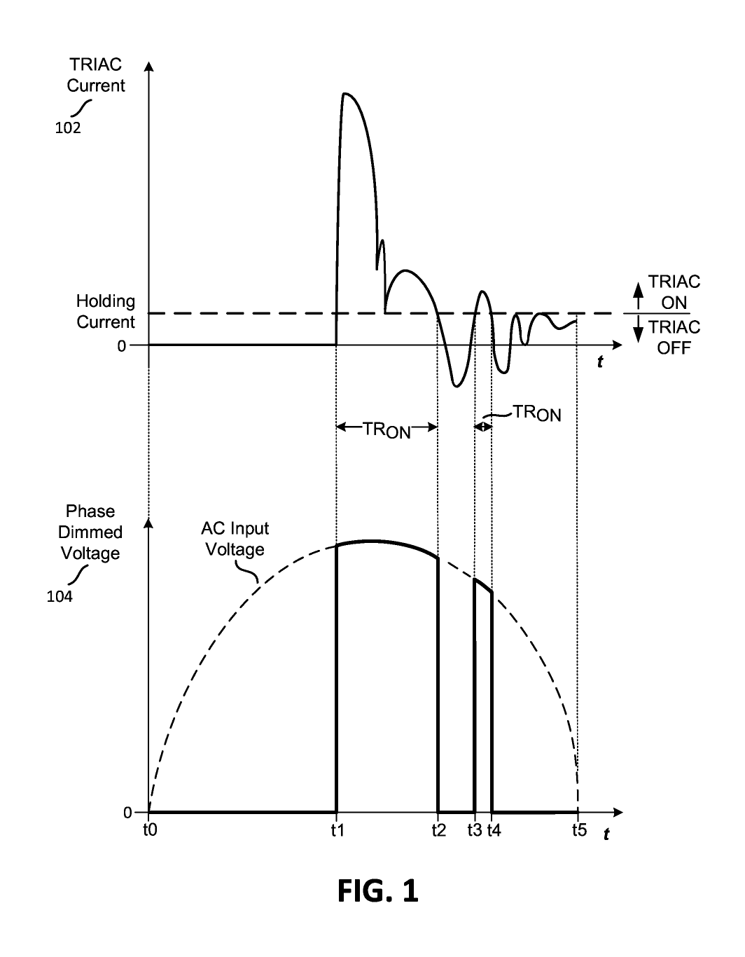

FIG. 2 is a functional block diagram illustrating one example of a power conversion system with a selective capacitor circuit in accordance with the teachings of the present disclosure.

FIG. 3 shows example waveforms that correspond to the signals at various nodes of the power conversion system illustrated in FIG. 2 in accordance with the teachings of the present disclosure.

FIG. 4 is a circuit diagram illustrating an example selective capacitor circuit according to the teachings of the present disclosure.

FIG. 5 shows example waveforms representing the signals at various nodes of the selective capacitor circuit shown in FIG. 4 in accordance with the teachings of the present disclosure.

FIG. 6 is a flowchart illustrating a method to selectively add a capacitance to an input of a power converter in a power conversion system in accordance with the teachings of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. In addition, it is appreciated that the figures provided herewith are for explanation purposes to persons ordinarily skilled in the art and that the drawings are not necessarily drawn to scale.

This relates to an apparatus and method for selectively adding a capacitance to an input of a power converter of a power conversion system. Specifically, a power conversion system may selectively introduce additional input capacitance in response to an input voltage. In one example, a power conversion system operates in a first mode (dimming mode) and engages a selective capacitor circuit to introduce additional capacitance to an input of a power converter. In a second mode (non-dimming mode), the power conversion system disengages the selective capacitor circuit from the input of the power converter.

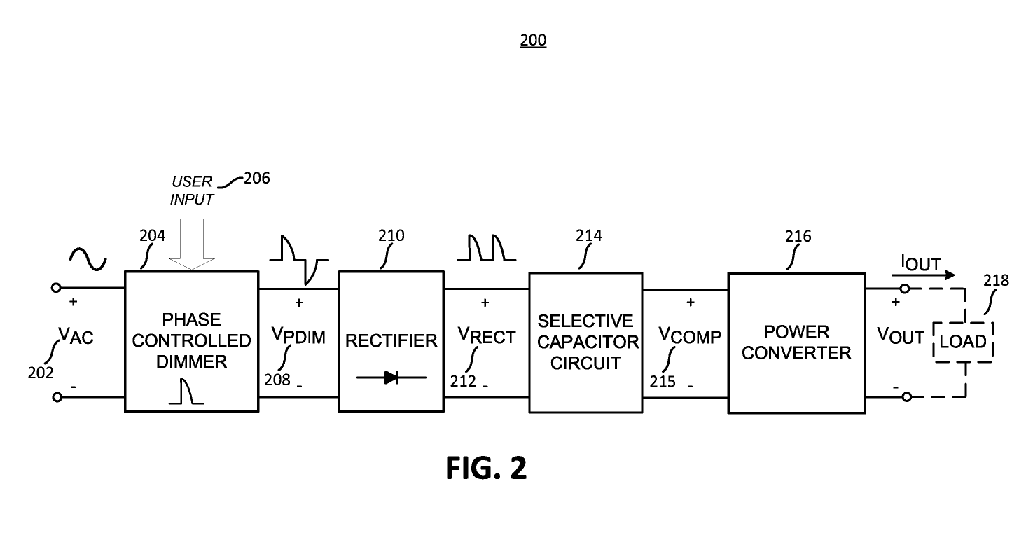

FIG. 2 illustrates a functional block diagram of an example power conversion system 200 that uses a selective capacitor circuit 214 in accordance with the teachings of the present disclosure. The illustrated power conversion system 200 includes a phase controlled dimmer 204, a rectifier circuit 210, a selective capacitor circuit 214, a power converter 216, also referred to as a power supply, and a load 218.

Power conversion system 200 provides output power to load 218 from an unregulated input voltage V_{AC} 202, also referred to as a line signal. In one embodiment, input voltage V_{AC} 202 is a periodic ac line voltage. Input voltage V_{AC} 202 is coupled to a phase controlled dimmer 204. In one embodiment, phase controlled dimmer 204 may include a dimmer that blocks a portion of the leading edge of the input voltage. However, it is appreciated that either a trailing edge or leading edge dimmer may be used. As shown, phase controlled dimmer 204 receives a user input 206 and is coupled to rectifier circuit 210 and selective capacitor circuit 214. In one embodiment, rectifier circuit 210 may include a full bridge rectifier. However, it should be appreciated that other known rectifier circuits may be used. As further shown, selective capacitor circuit 214 is coupled to a power converter 216, which regulates an output quantity across load 218. The output quantity regulated across load 218 may be an output voltage V_{OUT}, an output current I_{OUT}, or combination thereof.

In operation, phase controlled dimmer 204 may be selectively controlled via user input 206 to limit the amount of power supplied to power converter 216. Subsequently, receiving less power from the input line, power converter 216 may lower the amount of current delivered to load 218. In one example, when load 218 includes an array of LEDs, total light output is reduced, resulting in dimming of the array of LEDs. In one embodiment, phase controlled dimmer 204 may include a triac dimmer. In another embodiment, phase controlled dimmer 204 may include one of many known semiconductor switches, such as a metal oxide semiconductor field effect transistor (MOSFET). In one example, phase controlled dimmer 204 may block the input voltage V_{AC} 202 for a portion of each line cycle from power converter 216 at the beginning of each line cycle. In another example, phase controlled dimmer 204 may block the trailing end of the input voltage V_{AC} 202. In either example, after a certain amount of time, phase controlled dimmer 204 may reconnect input voltage V_{AC} 202 to power converter 216. In general, the portion of the input voltage V_{AC} 202 that is blocked from power converter 216 is related to the amount of dimming desired. In some examples, the larger the blocked portion of the input voltage, the more pronounced the dimming effect.

As shown in FIG. 2, phase controlled dimmer 204 receives input voltage V_{AC} 202 and produces phase dimmed voltage V_{PDIM} 208 in response to the user input 206. Rectifier circuit 210 is coupled to receive phase dimmed voltage V_{PDIM} 208 and is further coupled to output a rectified phase dimmed voltage V_{RECT} 212. In other words, V_{RECT} 212 may be defined as a rectified phase dimmed voltage V_{PDIM} 208. As shown, selective capacitor circuit 214 receives rectified phase dimmed voltage V_{RECT} 212 and generates a compensated voltage V_{COMP} 215 in response to phase dimmed voltage V_{RECT} 212. More particularly, selective capacitor circuit 214 determines whether phase dimming is taking place and outputs compensated voltage V_{COMP} 215 accordingly. If no phase dimming is detected, compensated voltage V_{COMP} 215 substantially follows rectified phase dimmed voltage V_{RECT} 212. However, if phase dimming is detected, selective capacitor circuit 214 switches to a dimming mode and introduces a capacitor (not shown) across the input of power converter 216. As a result, rectified phase dimmed voltage V_{RECT} 212 is further filtered by the additional capacitor, producing a substantially dc voltage for compensated voltage V_{COMP} 215. In operation, power converter 216 receives compensated voltage V_{COMP} 215 and in response, generates a substantially constant output across load 218.

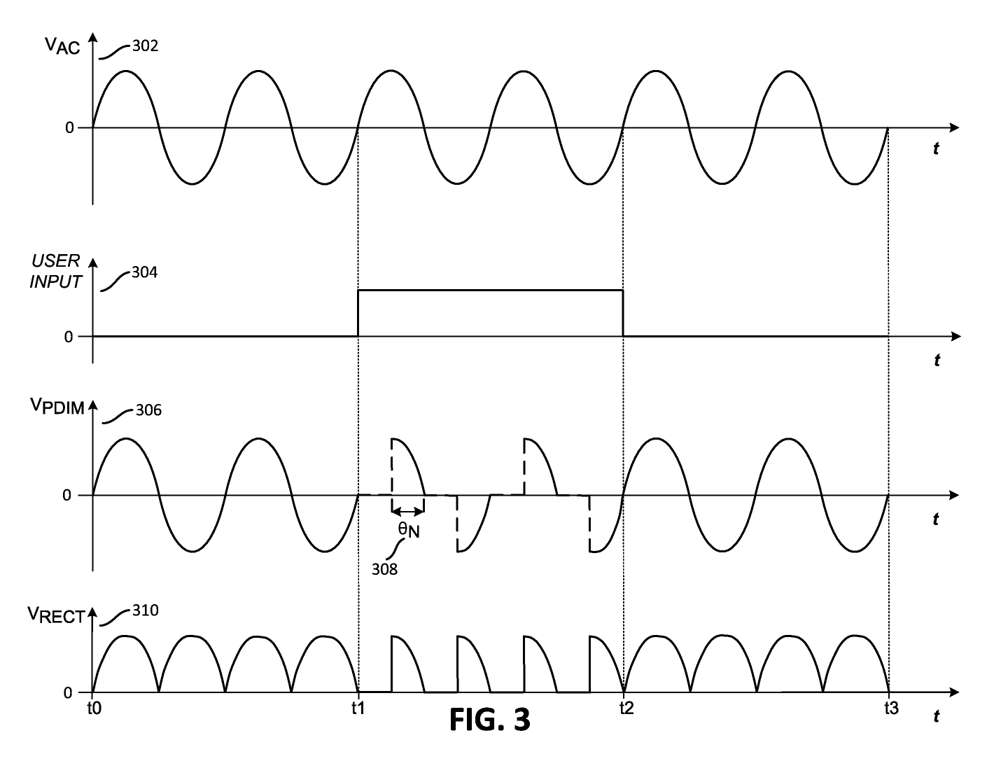

FIG. 3 shows example waveforms corresponding to the signals at various nodes of power conversion system 200. Waveform 302 is one possible representation of the input voltage V_{AC} 202. In one example, user input 206 is a signal with logic low and logic high levels and waveform 304 is one possible representation of this signal. Waveform 306 is one example waveform that is representative of the phase dimmed voltage V_{PDIM} 208. As shown, waveform 302 is illustrated as a periodic sine wave comprising a plurality of continuous cycles. As further shown, user input 304 switches between a logic low and a logic high voltage. More specifically, user input 304 switches from logic low to logic high at time t1 and from logic high to logic low at time t2. It is further illustrated in FIG. 3 that during the time user input 304 is at logic low, phase dimmed voltage V_{PDIM} 306 is substantially equal to input voltage V_{AC} 302 and when user input 304 transitions to logic high, a portion of the input voltage is blocked resulting in phase dimmed voltage V_{PDIM} 306 that represents only a portion of the line signal. In other words, between time t1 and t2, a portion of the phase dimmed voltage V_{PDIM} 306 at the leading edge of each ac input half cycle is equal to zero volts as phase controlled dimmer 204 blocks input voltage 202 from power converter 216. For the remaining parts of each half cycle, phase dimmed voltage V_{PDIM} 306 follows input voltage V_{AC} 302 as phase controlled dimmer 204 reconnects input voltage V_{AC} 102 to power converter 216.

As shown in waveform 306, a conduction angle θ_{N} 308 denotes the portion of input voltage V_{AC} 202 that is outputted by phase controlled dimmer 204 during each half cycle (i.e., half period) of the input voltage. Conduction angle θ_{N} 308 is defined by a phase angle which represents the fraction of the period of input voltage V_{AC} 202 that is not blocked by phase controlled dimmer 304. As such, an entire period (full cycle) of input voltage corresponds to 360 degrees, and half the period (half cycle) of input voltage corresponds to 180 degrees in phase angle. In operation, phase controlled dimmer 204 can adjust conduction angle θ_{N} 308 in response to user input 304. Waveform 310 is representative of an example of rectified phase dimmed voltage V_{PDIM} 212 which is generated by rectifier circuit 210 where portions of the phase dimmed voltage V_{PDIM} 212 that are lower than zero volts (i.e., negative) are rectified to positive voltages of equal magnitude.

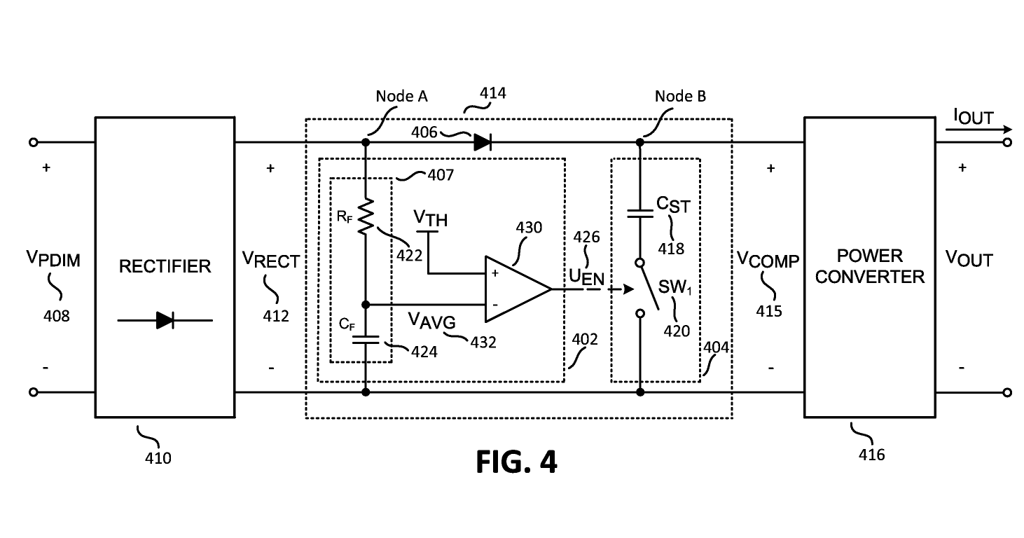

FIG. 4 is a functional block diagram illustrating an example selective capacitor circuit 414, in accordance with the teachings of the present disclosure. The exemplified selective capacitor circuit 414 includes an example input detection circuit 402, an example storage capacitor circuit 404, and a diode 406. The illustrated example of input detection circuit 402 includes a resistor 422, a capacitor 424, and a comparator 430. Other known circuit configurations, such as a zero-crossing detector, can also be used to implement input detection circuit 402. The example storage capacitor circuit 404 includes a storage capacitor 418 and a switch SW₁ 420.

As illustrated in FIG. 4, input detection circuit 402 is coupled to receive rectified phase dimmed voltage V_{RECT} 412 and is further coupled to output an enable signal U_{EN} 426. In the illustrated example, storage capacitor circuit 404 is coupled across power converter 416 and further coupled to receive enable signal U_{EN} 426. As further shown, a diode 406 is coupled between input detection circuit 402 and storage capacitor circuit 404.

In the illustrated example, input detection circuit 402 receives rectified phase dimmed voltage V_{RECT} 412 and produces enable signal U_{EN} 426. In one example, enable signal U_{EN} 426 is a signal with logic low and logic high voltage levels. As further shown in FIG. 4, storage capacitor circuit 404 receives enable signal U_{EN} 426 from input detection circuit 402 and in response, transitions between an ON mode and an OFF mode. More particularly, storage capacitor circuit 404 is in an ON mode when switch SW₁ 420 is enabled or closed, and is in an OFF mode when switch SW₁ 420 is disabled or open. In one embodiment, storage capacitor circuit 404 transitions from OFF mode to ON mode when enable signal U_{EN} 426 transitions from logic low to logic high and similarly, transitions from ON mode to OFF mode when enable signal U_{EN} 426 transitions from logic high to logic low. In one example, when storage capacitor circuit 404 transitions from OFF mode to ON mode, additional capacitance is introduced at the input of power converter 416. Diode 406, shown in FIG. 4 as coupled between input detection circuit 402 and storage capacitor circuit 404, isolates Node A from Node B and thus, prevents the voltage at Node B from influencing the voltage at Node A.

It is further illustrated in FIG. 4 that input detection circuit 402 includes an example filter circuit 407 and a comparator 430 with a threshold voltage V_{TH}. As shown in the illustrated example, filter circuit 407 is coupled to receive rectified phase dimmed voltage V_{RECT} 412 and to provide an average phase dimmed voltage V_{AVG} 432 to comparator 430. Comparator 430 is further coupled to receive threshold voltage V_{TH} and to output enable signal U_{EN} 426.

In operation, filter circuit 407 receives rectified phase dimmed voltage V_{RECT} 412 and provides average phase dimmed voltage V_{AVG} 432 to comparator 430. Comparator 430 compares average phase dimmed voltage V_{AVG} 432 with threshold voltage V_{TH} and generates enable signal U_{EN} 426. In one example, comparator 430 outputs a logic high signal when average phase dimmed voltage V_{AVG} 432 is lower than threshold voltage V_{TH}, and outputs a logic low signal when average phase dimmer voltage V_{AVG} 432 is not lower than threshold voltage V_{TH}.

The example filter circuit 407 of input detection circuit 402 is further shown in FIG. 4 to include a resistor R_{F} 422 coupled to a capacitor C_{F} 424. In one embodiment, voltage across the capacitor C_{F} 424 is outputted from filter circuit 407. In operation, filter circuit 407 continuously averages the rectified phase dimmed voltage V_{RECT} 412 received at the input of the filter and generates an average phase dimmed voltage V_{AVG} 432. Thus, average phase dimmed voltage V_{AVG} 432 may represent the average value of one or more cycles of phase dimmed voltage V_{PDIM} 408.

Further shown in FIG. 4 is a storage capacitor circuit 404 comprising a storage capacitor C_{ST} 418 coupled to a switch SW₁ 420. Switch SW₁ 420 is further coupled to receive enable signal U_{EN} 426 from input detection circuit 402. In one example, switch SW₁ 420 is a MOSFET. However, in other examples, other types of switches may be used. As shown, switch SW₁ 420 of storage capacitor circuit 404 may be in an ‘ON’ state when the switch is closed (enabled) and current can conduct through the switch, and in an ‘OFF’ state when the switch is open (disabled) and current cannot substantially conduct through switch SW₁ 420. During operation, switch SW₁ 420 receives enable signal U_{EN} 426 and responds by switching between the ON state and the OFF state. In one example, when enable signal U_{EN} 426 is a logic high signal, switch SW₁ 420 operates in the ON state and thereby electrically couples storage capacitor C_{ST} 418 to the input of power converter 416. Conversely, when enable signal U_{EN} 426 is a logic low signal, switch SW₁ 420 operates in the OFF state and disconnects storage capacitor C_{ST} 418 from the input of power converter 416. Coupling storage capacitor C_{ST} 418 to the input of power converter 416 allows for a steady supply of power to power converter 416 when a portion of the input voltage is blocked but may also degrade PFC. In some instances, such as dimming, however, power factor may not be measured, and therefore, PFC may not be needed.

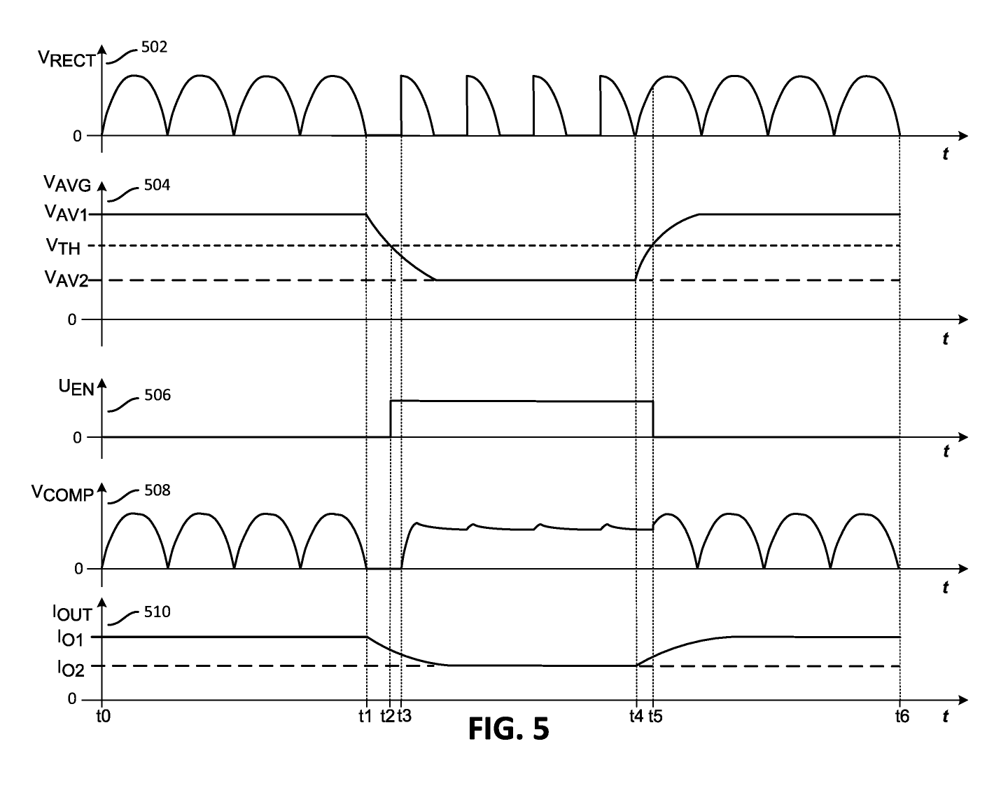

FIG. 5 illustrates example waveforms representing the signals at various nodes of the selective capacitor circuit 414 shown in FIG. 4. Waveform 502 is one possible representation of rectified phase dimmed voltage V_{RECT} 412 at the output of the rectifier circuit 410. Waveform 504 is representative of the average phase dimmed voltage V_{AVG} 432 received by comparator 430 of the input detection circuit 402. Waveforms 506 and 508 illustrate examples of enable signal U_{EN} 426 at the output of input detection circuit 402 and compensated voltage V_{COMP} 415 at the output of selective capacitor circuit 404, respectively. Further included in FIG. 5 is an example output current waveform I_{OUT} 510 representative of output current I_{OUT} at the output of power converter 416.

As previously stated, average phase dimmed voltage V_{AVG} 432 is generated by filter circuit 407 that continuously averages rectified phase dimmed voltage V_{RECT} 412. As shown in waveform 502, during time periods t0-t1 and t4-t6, rectified phase dimmed voltage V_{RECT} 502 consists of a number of consecutive half cycles and as shown in waveform 504, the resultant average phase dimmed voltage is substantially constant at a value of V_{AV1} during t0-t1 and a portion of t4-t6. Between time t1 and t4, however, a portion of each half cycle of rectified phase dimmed voltage V_{RECT} 502 becomes zero volts since the same portion of each half cycle of line signal is blocked by a phase controlled dimmer, such as a triac dimmer. This causes average phase dimmed voltage V_{AVG} 504 to decrease from its initial value of V_{AV1}. Once average phase dimmed voltage V_{AVG} 504 reaches the threshold voltage V_{TH}, which is shown to occur at time t2 in FIG. 5, enable signal U_{EN} 506 from comparator 430 transitions from a logic low to a logic high voltage. In one example, threshold voltage V_{TH} of FIG. 5 corresponds to threshold voltage V_{TH} illustrated in FIG. 4. In response, storage capacitor circuit 404 transitions to an ON mode and thereby, couples storage capacitor C_{ST} 418 to the input of the power converter 416. Meanwhile, average phase dimmed voltage V_{AVG} 504 continues to drop until eventually settling at a lower value V_{AV2} where it remains substantially constant until time t4. At time t4, average phase dimmed voltage V_{AVG} 504 starts to increase as the phase controlled dimmer reconnects line signal to the input of power converter 416. As soon as average phase dimmed voltage V_{AVG} 504 increases past threshold voltage V_{TH} (at time t5), enable signal U_{EN} 506 then transitions from a logic high to a logic low voltage, thereby causing storage capacitor circuit 404 to transition to an OFF mode. Storage capacitor C_{ST} 418 is then disengaged from the input of the power converter 416. Average phase dimmed voltage V_{AVG} 504 continues to increase before reaching voltage V_{AV1} at some point during time period t4-t6 and thereupon remains substantially constant at voltage V_{AV1} until time t6. The rate of change at which average phase dimmed voltage V_{AVG} 504 increases or decreases depends on certain characteristics of filter circuit 407, such as the time constant, and can be adjusted by changing the component values inside the filter circuit. In one example, average phase dimmed voltage 504 may reach the threshold V_{TH} voltage within one line cycle. In another example, average phase dimmed voltage 504 may need several line cycles to reach the threshold voltage V_{TH}.

As further illustrated in FIG. 5, when storage capacitor circuit 404 operates in OFF mode during t0-t2 and t5-t6, compensated voltage V_{COMP} 508 substantially follows rectified phase dimmed voltage V_{RECT} 502. This is because storage capacitor C_{ST} 418 is disengaged from the input of the power converter 416 and thus, does not influence compensated voltage V_{COMP} 508. Storage capacitor circuit 404 transitions to an ON mode at time t2, coupling storage capacitor C_{ST} 418 to the input of the power converter 416. Between time t1 and t3, rectified phase dimmed voltage V_{RECT} 502 is zero volts and as a result, cannot provide any charge to storage capacitor C_{ST} 418. Since storage capacitor C_{ST} 418 is initially uncharged, compensated voltage V_{COMP} 508 will also remain at zero volts until time t3. Following the sudden rise of the rectified phase dimmed voltage V_{RECT} 502 at time t3, storage capacitor C_{ST} 418 begins charging as indicated by increasing compensated voltage V_{COMP} 508. When compensated voltage V_{COMP} 508 equals rectified phase dimmed voltage V_{RECT} 502, storage capacitor C_{ST} 418 stops charging. With no voltage source available to provide charge, storage capacitor C_{ST} 418 discharges until the next half cycle. In other words, compensated voltage V_{COMP} 508 declines until the next half cycle where storage capacitor C_{ST} 418 starts charging back when declining voltage equals to the rising input voltage. In this manner, storage capacitor C_{ST} 418 produces substantially constant dc voltage for compensated voltage V_{COMP} 508 between time t3 and t5.

In the exemplary waveform of 510, output current I_{OUT} of power converter 416 is shown. With compensated voltage V_{COMP} 508 following rectified phase dimmed voltage V_{RECT} 502 during time period t0-t1, power converter 416 produces a substantially constant output current of Iₒ₁. At time t1, phase controlled dimmer begins to block a portion of each half cycle of line signal from the input of power converter 416 and in turn, the same portion of each half cycle of the rectified phase dimmed voltage V_{RECT} 502 becomes zero volts. Accordingly, power converter 416 begins to decrease output current I_{OUT}. Output current I_{OUT} first decreases from Iₒ₁ to Iₒ₂ and then remains regulated at Iₒ₂ until time t4 as compensated voltage V_{COMP} 508 stabilizes during this time. At time t4, phase controlled dimmer reconnects line signal to the input of power converter 416 and in response, power converter 416 begins to increase the output current I_{OUT}. With compensated voltage V_{COMP} 508 returning to follow rectified phase dimmed voltage V_{RECT} 502, output current I_{OUT} increases from Iₒ₂ to Iₒ₁ and remains regulated thereafter until time t6. In one example, output current I_{OUT} may be adjusted to one or more values and each value may represent a different light output. In this manner, an LED load coupled to the output of a power converter may receive a different output current I_{OUT} depending on the portion of the input voltage that is blocked with a triac dimmer.

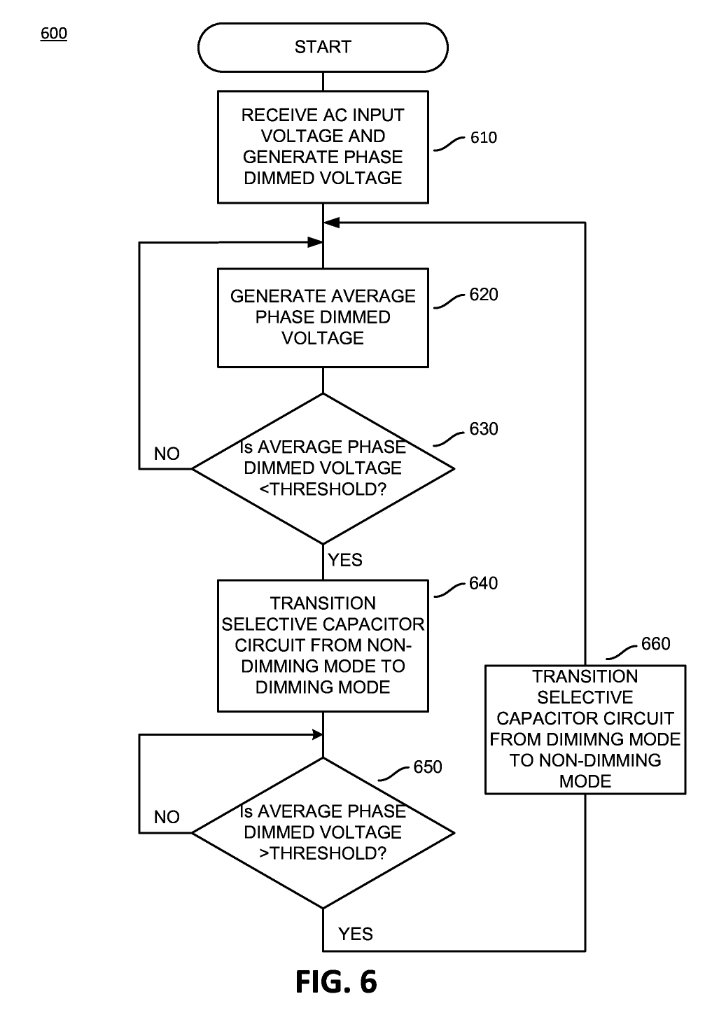

Referring to FIG. 6, a flowchart 600 illustrates a method for selectively coupling a storage capacitor to an input of the power converter of a power conversion system. At block 610, power conversion system receives an ac input voltage, such as V_{AC} 202 of FIG. 2, and in response, generates a phase dimmed voltage, such as V_{PDIM} 408 of FIG. 4 that is representative of a portion of the ac input voltage. In one example, the power conversion system may include a dimmer, such as phase controlled dimmer 204 of FIG. 2, to generate phase dimmed voltage V_{PDIM} in response to ac input voltage V_{AC}. At block 620, an average phase dimmed voltage, such as V_{AVG} 432 of FIG. 4, is generated by continuously averaging the phase dimmed voltage V_{PDIM}. In one example, generating the average phase dimmed voltage V_{AVG} can be accomplished by transmitting the phase dimmed voltage V_{PDIM} to a filter similar or identical to filter circuit 407 of FIG. 4. At block 630, average phase dimmed voltage V_{AVG} is compared with a threshold, such as threshold voltage V_{TH} of FIG. 4, to determine the occurrence of a phase dimming event. When average phase dimmed voltage V_{AVG} is lower than threshold V_{TH}, which indicates the occurrence of a phase dimming event, process 600 proceeds to block 640. However, if the average phase dimmed voltage is not lower than threshold V_{TH}, which indicates the absence of a phase dimming event, process 600 returns to block 620. In one example, input detection circuit 402 can be used to perform the comparison between average phase dimmed voltage V_{AVG} and threshold V_{TH}. At block 640, a selective capacitor circuit, such as selective capacitor circuit 414 of FIG. 4, transitions from non-dimming mode to dimming mode and as a result, couples a storage capacitor, such as C_{ST} 418, to an input of the power converter. At block 650, average phase dimmed voltage V_{AVG} is again compared with threshold V_{TH} and if found to be greater than threshold V_{TH}, process 600 proceeds to block 660. At block 660, selective capacitor circuit 414 transitions from dimming mode to non-dimming mode and storage capacitor C_{ST} is disengaged from the input of the power converter.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. A power conversion system comprising:
a power converter; and
a selective capacitor circuit coupled across the power converter and coupled to receive a phase dimmed voltage representative of a portion of an alternating current (ac) input voltage, wherein the selective capacitor circuit is operable to selectively add a capacitance to an input of the power converter in response to the phase dimmed voltage.

2. The power conversion system of claim 1, wherein the phase dimmed voltage is received from a phase controller dimmer.

3. The power conversion system of claim 2, wherein the phase dimmed voltage is determined in response to a user input.

4. The power conversion system of claim 1, wherein the power conversion system comprises a light emitting diode (LED) driver.

5. The power conversion system of claim 1, further comprising a rectifier coupled to output the phase dimmed voltage to the selective capacitor circuit, wherein the phase dimmed voltage is a rectified phase dimmed voltage.

6. The power conversion system of claim 1, wherein the selective capacitor circuit comprises an input detection circuit and a storage capacitor circuit.

7. The power conversion system of claim 6, wherein the input detection circuit comprises a comparator coupled to a filter circuit to output an enable signal.

8. The power conversion system of claim 7, wherein the storage capacitor circuit comprises a storage capacitor coupled to a switch, wherein the switch electrically couples the storage capacitor to the input of the power converter in response to the enable signal.

9. The power converter of claim 7, wherein the selective capacitor circuit comprises a storage capacitor coupled to a switch, wherein the switch selectively switches between an ON state and an OFF state in response to the enable signal.

10. The power converter of claim 6, wherein the input detection circuit provides an averaged phase dimmed voltage in response to the phase dimmed voltage.

11. The power converter of claim 10, wherein the enable signal is generated in response to the average phased dimmed voltage.

12. A power converter, comprising
a selective capacitor circuit coupled to selectively add a capacitance to an input of a power converter in response to a user input.

13. The power converter of claim 12, wherein the selective capacitor circuit comprises a storage capacitor circuit.

14. The power converter of claim 12, wherein the storage capacitor circuit comprises a storage capacitor coupled to a switch, wherein the switch electrically couples the storage capacitor to the input of the power converter in response to the user input.

15. A method comprising:
receiving a phase dimmed voltage that is representative of a portion of an alternating current (ac) input voltage;
generating an average phase dimmed voltage by averaging a value of the phase dimmed voltage;
comparing the average phase dimmed voltage with a threshold voltage to detect an occurrence of a phase dimming event; and
switching a selective capacitor circuit between a dimming mode and a non-dimming mode in response to the phase dimming event.

16. The method of claim 15 further comprising generating a rectified ac input voltage in response to the phase dimmed voltage.

17. The method of claim 15, wherein receiving the phase dimmed voltage comprises receiving a voltage from a phase controlled dimmer.

18. The method of claim 15, wherein switching the selective capacitor circuit between the dimming mode and the non-dimming mode selectively couples a storage capacitor to an input of a power converter.

19. The method of claim 15, wherein generating the average phase dimmed voltage comprises transmitting the phase dimmed voltage to a filter circuit to generate the average phase dimmed voltage.

20. A power conversion system, comprising:
an input detection circuit coupled to receive a phase dimmed voltage that is representative of a portion of an ac input voltage and further coupled to output an enable signal to switch a switch of a selective capacitor circuit between an ON state and an OFF state in response to the phase dimmed voltage; and
a power converter coupled to the selective capacitor circuit, wherein an input capacitance of the power converter is changed in response to the switching of the switch.
